(19) United States
(12) Patent Application Publication
(10) Pub. No.: US 2021/0246931 A1
(43) Pub. Date: Aug. 12, 2021

(54) INSERT FOR VEHICLE WHEELS

(71) Applicant: ZANINI AUTO GRUP, S.A., Barcelona (ES)

(72) Inventors: Miguel CASANOVAS CEJUELA, Barcelona (ES); Montserrat BLANCH ALERANY, Barcelona (ES); Pedro DURÁN BOFILL, Barcelona (ES)

(21) Appl. No.: 17/167,642

(22) Filed: Feb. 4, 2021

(30) Foreign Application Priority Data
Feb. 10, 2020 (EP) 20382087.3

(51) Int. Cl. F16B 37/14; B60B 7/08

(52) U.S. Cl. CPC F16B 37/14; B60B 7/08

(57) ABSTRACT

The insert for vehicle wheels comprises an insert body (1) and fastening means that enable said insert to be fastened to a rim (4) of a wheel, wherein said fastening means comprise at least one retaining element (2) provided with a step (22); and at least one fastening element (3) covering the or each retaining element (2), the or each fastening element (3) comprising at least one tab (33) that is coupled to said step (22).

The invention provides an insert for use thereof in a wheel of a vehicle that is inexpensive and can be easily mounted from the front portion thereof, but which has an anti-theft system that prevents the removal thereof from the front portion and enables most of said insert to be made of a material that does not require high thermal resistance.

### CROSS-REFERENCE TO RELATED APPLICATIONS

This application claims priority pursuant to 35 U.S.C. 119(b) and 37 CFR 1.55 to European Patent Application n° 20382087.3 filed on 10 Feb. 2020 (DAS CODE: 1CF4), the entire disclosure of which is incorporated herein by reference.

### DESCRIPTION

The present invention relates to an insert for vehicle wheels, comprising means for fastening thereof to the wheel of the vehicle.

### BACKGROUND OF THE INVENTION

Inserts are commonly used on the wheels of vehicles to customise their appearance. These inserts are normally made of plastic material and are fastened to the rim of the wheel, which is made of metal.

The inserts must be reliably fastened to the rim of the vehicle wheel, which prevents the inserts from detaching from the rim for a long time, taking into account the stresses to which they are subjected due to the speed of rotation of the wheel, wind force, and vibrations.

Currently, various types of fastening means for fastening these inserts to the rims of the vehicle are known.

A first type of insert is joined to the rims of the wheels by means of screws, which must be screwed from inside the wheel. This type of fastening means has the advantage that they are very reliable, since the joining between the insert and the wheel is very long-lasting. However, this type of fastening means has the drawback that they are uncomfortable to mount, since they require screwing from the inner portion of the wheel.

The methods of fastening the plastic inserts to the rim by means of screws from inside the wheel mean that the mounting of the plastic inserts is carried out by the rim supplier and not in the assembly line of the vehicle manufacturer. The vehicle manufacturer is in favour of the frontal mounting of the plastic inserts on the rim in the assembly line thereof. The fastening system of the plastic inserts by means of screws from inside the rim forces the vehicle manufacturer to make more space in their manufacturing plant for the storage of rims with different plastic insert references. This scenario is especially critical when a large number of plastic insert references (different colours) can be mounted on the same rim reference. Therefore, the fastening system for fastening the inserts by means of screws from inside the rim greatly hinders the flexibility desired by the vehicle manufacturer when customising the wheel of the vehicle by mounting different plastic inserts on the rim.

A second type of insert is joined to the rims by means of adhesive, for example, a two-sided adhesive tape. In practice, this fastening system has proven not to be adequate, since the fastening thereof is permanent and does not enable the insert to be removed and replaced by another.

Moreover, WO 2015/059317 A1, of the same holder as the present application, discloses an insert for vehicle wheels comprising fastening means comprising a plurality of projections, each of which is associated with a fastening element.

### DESCRIPTION OF THE INVENTION

Therefore, there is a clear need for an insert for use thereof in a wheel of a vehicle that is as inexpensive as possible and that can be easily mounted from the front portion thereof, but that has an anti-theft system preventing the removal thereof from the front portion and enables most of said insert to be made of a material which does not require high thermal resistance.

The mentioned drawbacks are resolved with the insert for wheels of the invention, while presenting other advantages which will be described below.

The insert for vehicle wheels according to the present invention comprises an insert body and fastening means that enable said insert to be fastened to a rim of a wheel, wherein said fastening means comprise:

at least one retaining element provided with a step and

at least one fastening element covering the or each retaining element, the or each fastening element comprising at least one tab that is coupled to said step.

Advantageously, said at least one retaining element and said at least one fastening element are made of plastic material, the use of any metal element not being necessary.

According to a preferred embodiment, the or each fastening element is formed by two halves joined in an articulated manner at one of the ends thereof.

Advantageously, to facilitate the frontal insertion of the insert into the rim, the or each retaining element has a frustoconical-shaped tip, and the or each fastening element also has a frustoconical-shaped tip preferably complementary to the retaining element tip.

To provide adequate retention, said tab of the or of each fastening element is inclined inwardly towards the fastening element.

According to a preferred embodiment, the or each retaining element is joined to the insert body by means of the placement of a ring of the or of each retaining element inside a housing of said insert body.

The ring is preferably square-shaped, preventing the rotation of the retaining element when drilling with a drill for dismounting the insert.

According to this embodiment, said housing advantageously comprises an insertion slot for said retaining element.

Preferably, said ring is arranged at the end opposite from the frustoconical-shaped tip of said retaining element.

Furthermore, the or each fastening element comprises a fastening projection for fastening thereof to the rim of the wheel, and the or each fastening element comprises a stop projection for butting against the rim of the wheel.

According to a possible embodiment, the or each fastening element is joined to the or each retaining element before fastening to the rim.

In this embodiment, the joining between the or each fastening element and the or each retaining element is advantageously performed by means of joining bridges that break when fastening the insert to the rim.

Preferably, said joining bridges join the frustoconical-shaped tip of the retaining element with the inner portion of the stop projection of the fastening element.

Among others, the following advantages are achieved with the insert for wheels of the present invention:

It makes possible to mount the insert from the front portion, with the wheel already mounted on the vehicle;

It does not have any metal element, being completely made of plastic;

It cannot be dismounted from the front portion, since in order to dismount it, it is necessary to break a portion of the retaining element and, in that case, only by previously dismounting the wheel of the vehicle, such that it provides an anti-theft system;

It enables a more affordable material with lower thermal resistance to be used, because only a portion of the insert, in particular the retaining elements and the fastening elements, must be made of a material with high thermal resistance, which is more expensive, and the body of the insert can be made of a material with lower thermal resistance and that is cheaper.

### BRIEF DESCRIPTION OF THE DRAWINGS

In order to better understand what has been set forth, several drawings are attached wherein a practical embodiment is schematically depicted merely by way of non-limiting example.

FIG. 1 is a perspective view of a retaining element of the insert according to the present invention before being placed in a housing of the insert body;

FIG. 2 is a perspective view of a fastening element of the insert according to the present invention in the open position thereof;

FIG. 3 is a cross section view of the insert according to the present invention in the position of use thereof; and

FIG. 4 is a cross-sectional perspective view of an embodiment of a retaining element and a fastening element of the insert according to the present invention, wherein the retaining element and the fastening element are joined before being fastened to a rim of a wheel.

### DESCRIPTION OF A PREFERRED EMBODIMENT

The insert for wheels according to the present invention comprises:

an insert body 1,

at least one retaining element 2 that is joined to said insert body 1 and

at least one fastening element 3 that is fastened to a rim 4 of a vehicle wheel and is coupled to said retaining element 2.

It should be noted that the insert according to the present invention preferably comprises a plurality of retaining elements 2 and fastening elements 3, placed in adequate positions to ensure the correct fastening of the insert to the rim 4.

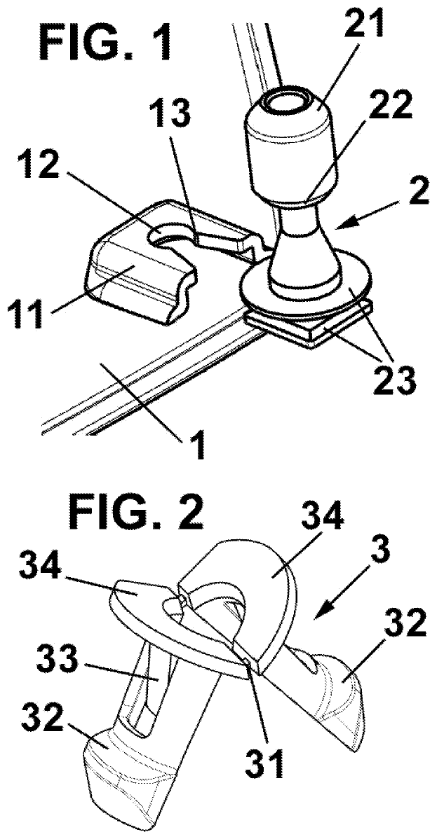

Said insert body 1 is the visible portion of the insert of the present invention and is preferably flat. According to the embodiment depicted, the joining thereof with the retaining element 2 is performed by means of a housing 11 provided with a slot 12 and a narrowing 13, as shown in FIG. 1.

Said insert body 1 is preferably made of plastic material, although it could be made of any suitable material.

On the other hand, the retaining element 2, which function is to retain the insert body 1 and enable the fastening element 3 to be coupled, comprises a frustoconical-shaped tip 21, a coupling step 22 and rings 23, at least one of them being square-shaped, these rings 23 being arranged at the end furthest from the frustoconical- shaped tip 21.

The frustoconical-shaped tip 21 facilitates the introduction of the insert into a hole of a rim of a wheel.

The coupling step 22 has the function of enabling the fastening element 3 to be coupled, as will be described below, and the rings 23, together with the narrowing 13, prevent the accidental removal of the retaining element 2 inside the housing 11 of the insert body 1.

As shown in FIG. 1, the portion between the coupling step 22 and the rings 23 is that which is placed at the height of the slot 12 of the housing 11, while one of the rings 23 is housed, at least partially, in said housing 11.

The retaining element 2 is advantageously made of a plastic material.

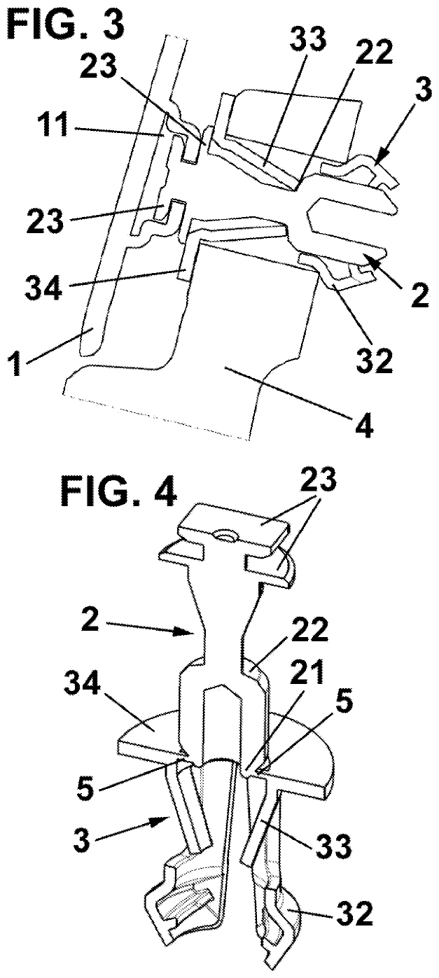

Furthermore, the insert according to the present invention comprises a fastening element 3, which in the position of use thereof is placed on the retaining element 2, as seen in FIG. 3, covering said retaining element 2.

Said fastening element 3 has a form that is substantially complementary to the retaining element 2. In particular, it comprises a frustoconical-shaped tip 31 and a fastening projection 32, which enables the insert to be fastened to a rim 4 of a wheel.

The fastening element 3 also comprises one or more tabs 33, two in the embodiment depicted, which are inclined inwardly and make contact with the step 22 of the retaining element 2, and a stop projection 34, which function is to butt against one of the rings 23 and against the front portion of the rim 4, as shown in FIG. 3.

The fastening element 3 is preferably formed by two halves articulated with each other at one end, in particular, at the end wherein the stop projection 34 is located, as shown in FIG. 2. Furthermore, said fastening element 3 is also preferably made of a plastic material.

In FIG. 3, the insert according to the present invention is shown in the position of use thereof, with the retaining element 2 joined to the insert body 1, the fastening element 3 coupled to the retaining element 2 and fastened to the rim 4 of a wheel.

As can be seen in this figure, the insert body 1 is placed entirely outside the rim 4 of the wheel, such that it can be manufactured with a material that does not require high heat resistance, since it will not be subject to heat produced by the brakes of the wheel.

An alternative embodiment of the insert according to the present invention is shown in FIG. 4. According to this embodiment, the only difference is that the retaining element 2 and the fastening element 3 are already joined to each other by joining bridges 5 before being placed in the position of use.

When placed in the position of use, with the fastening element 3 covering the retaining element 2, said joining bridges 5 break, since they are designed with a suitable thickness therefor.

Preferably, said joining bridges 5 join the frustoconical-shaped tip 21 of the retaining element 2 with the inner portion of the stop projection 34 of the fastening element 3.

Despite having referred to a specific embodiment of the invention, it is evident for one skilled in the art that the insert for wheels described is susceptible to a number of variations and modifications, and that all the aforementioned details can be replaced with other technically equivalent ones without detracting from the scope of protection defined by the attached claims.

1. An insert for vehicle wheels, comprising an insert body (1) and fastening means that enable said insert to be fastened to a rim (4) of a wheel, characterised in that said fastening means comprise:
at least one retaining element (2) provided with a step (22); and
at least one fastening element (3) covering the or each retaining element (2), the or each fastening element (3) comprising at least one tab (33) that is coupled to said step (22).

2. The insert for vehicle wheels according to claim 1, wherein said at least one retaining element (2) and said at least one fastening element (3) are made of plastic material.

3. The insert for vehicle wheels according to claim 1, wherein the or each fastening element (3) is formed by two halves joined in an articulated manner at one of the ends thereof.

4. The insert for vehicle wheels according to claim 1, wherein the or each retaining element (2) has a frustoconical-shaped tip (21).

5. The insert for vehicle wheels according to claim 1, wherein the or each fastening element (3) has a frustoconical-shaped tip (31).

6. The insert for vehicle wheels according to claim 1, wherein said tab (33) of the or of each fastening element (3) is inclined inwardly towards the fastening element (3).

7. The insert for vehicle wheels according to claim 1, wherein the or each retaining element (2) is joined to the insert body (1) by means of the placement of a ring (23) of the or of each retaining element (2) inside a housing (11) of said insert body (1).

8. The insert for vehicle wheels according to claim 7, wherein the ring (23) is square-shaped.

9. The insert for vehicle wheels according to claim 7, wherein said housing (11) comprises an insertion slot (12) for said retaining element (2).

10. The insert for vehicle wheels according to claims 4, wherein said ring (23) is arranged at the end opposite from the frustoconical-shaped tip (21) of said retaining element (2).

11. The insert for vehicle wheels according to claim 1, wherein the or each fastening element (3) comprises a fastening projection (32) for fastening thereof to the rim (4) of the wheel.

12. The insert for vehicle wheels according to claim 1, wherein the or each fastening element (3) comprises a stop projection (34) for butting against the rim (4) of the wheel.

13. The insert for vehicle wheels according to claim 1, wherein the or each fastening element (3) is joined to the or each retaining element (2) before fastening to the rim (4).

14. The insert for vehicle wheels according to claim 13, wherein the joining between the or each fastening element (3) and the or each retaining element (2) is performed by means of joining bridges (5) that break when fastening the insert to the rim (4).

15. The insert for vehicle wheels according to claims 14, wherein said joining bridges (5) join the frustoconical-shaped tip (23) of the retaining element (2) with the inner portion of the stop projection (34) of the fastening element (3).
